(19) United States
(12) Patent Application Publication
(10) Pub. No.: US 2005/0036462 A1
(43) Pub. Date: Feb. 17, 2005

(54) Method and system for performing relocation or anchoring in a wireless telecommunication network

(76) Inventors: Eero Sillasto, Helsinki (FI); Jeroen Wigard, Aalborg (DK)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/901,356

(22) Filed: Jul. 29, 2004

Related U.S. Application Data
(63) Continuation of application No. PCT/FI02/00096, filed on Feb. 8, 2002.

(51) Int. Cl. H04Q 7/00

(52) U.S. Cl. 370/331

(57) ABSTRACT

The present invention concerns a method and system for avoiding unnecessary handovers, relocations and/or anchoring during packet calls in a wireless telecommunication system. Data to be sent to a mobile terminal is stored in a data buffer. The data is sent to the mobile terminal when the amount of data in the buffer exceeds a predetermined threshold value. When a relocation or anchoring request is received, relocation or anchoring is performed only if one or more conditions are fulfilled. The conditions are preferably timers or adaptive thresholds. In a preferred embodiment, anchoring is performed only if a first timer has expired and relocation is performed only if the first and the second timers have both expired. When a handover is done, it triggers either anchoring or relocation. Therefore, the present invention lowers the number of handovers needed, and thus the number of anchoring and relocation cases.

### FIELD OF THE INVENTION

The present invention relates to mobile telecommunication systems. In particular, the present invention relates to a novel and improved method and system for avoiding unnecessary handovers, relocation and/or anchoring especially for packet services.

### BACKGROUND OF THE INVENTION

The Radio Resource Management (RRM) in the GERAN (GSM/EDGE Radio Access Network; GSM, Global System for Mobile Communications; EDGE, Enhanced Data rates for GSM Evolution) and the UTRAN (Universal Terrestrial Radio Access Network) are responsible for the utilisation of air interface resources. The RRM is needed for e.g. maintaining the QoS (Quality of Service), the planned coverage, and for offering high capacity. The RRM enables optimising service capacity and capability.

The full scope of the RRM is large, and several algorithms are needed to perform various tasks. These algorithms include, for example:

1. Power Control

2. Handover Control

3. Admission Control

4. Load Control

5. Packet Scheduler

6. Data rate control.

A handover in a wireless telecommunication network, such as the GSM or the Universal Mobile Telecommunications System (UMTS), is the mechanism that transfers an ongoing call from one cell to another. In case of a handover in the IP-RAN (Internet Protocol Radio Access Network), anchoring or relocation may take place (this may happen at the Base Station Gateway (BSGW) or in other places). Anchoring may also be used in the UTRAN. Anchoring is the process where the source after a handover still sends the user data packets to the old address and the old address sends them to the new address for transmission. This is done by tunnelling the packets from the old address to the new address. Relocation may be used in any or most of the networks. It is the traditional way of moving data buffers and protocol peers to a new point, such as Radio Network Controller (RNC) in the UTRAN, Internet Protocol Base Tranceiver Station (IP BTS) in the IPRAN or Base Station Controller (BSC) in the General Packet Radio Service (GPRS), in the EGPRS or in the GERAN. Relocation is the mechanism of changing the place of the address, i.e. packets are sent directly to the new address.

Different wireless telecommunication networks may possess different kinds of properties so that soft handover, relocation, anchoring and hard handover may not all be available for use. Hard handover refers to a handover from one frequency to another, whereby all the old radio links in the user equipment are abandoned before the new radio links are established. Soft handover refers to an intra-frequency handover which occurs between sectors or cells within one base station (BS) and where the radio links are added and abandoned in such a manner that the user's device always keeps at least two radio links to the base station. In the UTRAN, radio handover (hard or soft) does not need to affect the handling of the user plane in the network. Therefore, it is possible to keep or not to keep the same Radio Network Controller (RNC), and further, it is possible to anchor the RNC or to relocate the RNC. When the Wideband Code-Division Multiple Access (WCDMA) is used, soft handover is possible, e.g. in the UTRAN or WCDMA based IP-RAN. When Time Division Multiple Access (TDMA) is used (e.g. in the GSM, GPRS, EGPRS) like in GSM or GERAN based IP-RAN, only hard handover and relocation may be possible.

Each relocation may increase the network load, while anchoring may increase the transmission delay of data packets. Therefore unnecessary relocations and anchoring should be avoided. Relocation is a “fast” procedure that moves all information (user and control plane information) of the connection to another instant. There is a possibility of some loss of information, and that may affect the user plane transmission. And even if the relocation is “fast”, it may not be fast enough, and it may thus affect transport protocols, like TCP, causing retransmission. On the other hand, anchoring is probably the longer lasting state so the transmission network is loaded more.

Anchoring and relocation have quite an impact on the capacity of the last part of the transmission to the user (the last mile). This means that the gain from decreasing the number of relocations and anchoring is high, since the last mile of the transmission is the most expensive one. For longer calls, like speech calls, relocations and anchoring cannot necessarily be avoided, but for short packet calls, it can be done in most of the cases. A packet service session contains one or several packet calls depending on the application. During a packet call several packets may be generated, so that the packet call constitutes a bursty sequence of packets. Therefore, a packet call can be defined as an arriving data sequence where the packets are not separated by a long silent period of time.

From handover algorithms and area update algorithm, several algorithms are known to minimise the number of handovers and area updates. They are either using hysteresis or a timer. Hysteresis may be the difference between thresholds Th₁ and Th₂, where the Th₁ is triggered when a certain parameter increases, while Th₂ is triggered when the same parameter decreases. When Th₁=Th₂, the hysteresis is equal to zero.

When trying to avoid anchoring and relocations for short packet calls, one problem is that it is not known in advance how long a packet call will last. The network just sees data arriving in a buffer. Another problem is that ping-pong handovers can happen. A ping-pong situation basically means that a system switches frequently between two different states. In case of a handover it means that a handover between cell A and cell B and back is made frequently.

FIG. 1 shows a model of a Non Real Time (NRT) session. In FIG. 1, a startphase and an end-phase can be seen. As presented in FIG. 1, a packet call may use the Transmission Control Protocol (TCP) slow start. In the NRT traffic there are a lot of silent periods, i.e. between the packet calls and between the packets in the startphase, when nothing is sent. The size of each packet call depends on the application. The packets during the start and end phase are typically below 100 bytes. The reading time is typically specified as a number of seconds.

In prior art, relocation and anchoring are performed when triggered due to e.g. signal level, quality or power budget. Therefore, unnecessary relocations and anchoring cases occur. Relocation increases the network's signalling and also transmission load, whereas anchoring may delay the service and increases the transmission and signalling load of the network.

### SUMMARY OF THE INVENTION

The present invention describes a method and system for avoiding unnecessary handovers, relocation and/or anchoring during packet calls in a wireless telecommunication system. The wireless telecommunication network comprises a data buffer where data to be sent to a mobile terminal is stored. The method presented in the invention is used when the amount of data in the buffer exceeds a predetermined threshold value. The data from the buffer is sent to the mobile terminal. Relocation or anchoring is performed only if one or more conditions are fulfilled, when relocation or anchoring is requested.

In a preferred embodiment, when the predetermined threshold value is exceeded and the data is sent to the mobile terminal, a first timer for carrying out a relocation or an anchoring procedure is started, and when relocation or anchoring is requested, relocation or anchoring is performed only if the first timer has expired. In another embodiment, data is sent to the mobile terminal when the amount of data in the buffer exceeds a predetermined threshold value. A first timer and a second timer for carrying out a relocation or an anchoring procedure are started, and when relocation or anchoring is requested, performing anchoring only if the first timer has expired, or performing relocation only if the first and the second timers have expired. The timers must be started again when the data in the buffer exceeds the threshold value next time. It must be noted that data can be sent to the mobile terminal even if the buffer contains less data than the threshold value. In this case, however, the method presented here should not be used.

In the aforementioned embodiments where the connection to which the anchoring or relocation is requested is not in a soft handover, the rejection of the anchoring or relocation may also be a rejection of a hard handover.

The same effect can be achieved also with adaptive thresholds, e.g. by using adaptive hysteresis.

By setting a first timer at the start of a connection, during which hard handovers, relocation and anchoring are forbidden, the amount of relocations and anchoring during the start can be decreased. The timer should be reset when relocation is made (relocation is a start of a connection from the algorithm point of view). The same effect can be achieved by using adaptive hysteresis, which is extra high at the start of the transmissions, and is then lowered after a certain time to the normal hysteresis level. However, if soft handover is possible, soft handover legs can be limited by high hysteresis limits.

To avoid unnecessary relocations, a second timer is started at the start of a connection. The second timer should be longer than the first one. Only when the second timer has expired, relocations can be made. When the first timer expires, anchoring can be used. The same effect can be achieved by setting a higher hysteresis for relocations than for anchoring.

In one embodiment it is relocation that is specially avoided for packet calls. However, if either relocation or anchoring was to be used, anchoring should be allowed. For example, if the first timer is not used, the second timer chooses either relocation or anchoring to be performed. Then, anchoring should be preferred for some time.

The transmission of a packet call takes typically less than a few seconds. During this period it is very likely that the signal level will stay quite constant, i.e. during the packet call transmission no relocation or anchoring should be done. During the silent periods relocation can be made, since no delay will be noticed (no data is transmitted). When the quality decreases very fast, the timer may prevent a relocation and anchoring case. This may lead to a very bad quality or even call drops. This can be prevented by allowing only certain kinds of handovers even if the timer has not expired.

The present invention has several advantages over the prior-art solutions. The present invention lowers the delay of the packet calls, and less transmission and signalling capacity is used for the cases when anchoring is used. Less network transmission capacity and less signalling capacity are used when relocations are made. A further advantage is that the Quality of Service (QoS) may be better because relocations are not performed so often.

With the solution of the present invention it is possible to balance the usage of relocation and anchoring in an optimum way. For example, to anchor the shortest packet calls and to perform relocation only when needed. This minimises the risk of errors in relocation but does not use the transmission network too much in anchoring.

When a handover is done, it usually triggers either anchoring or relocation. The present invention lowers the number of handovers and thus the number of anchoring and relocation cases.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a model of a Non Real Time (NRT) traffic,

FIG. 2 is a block diagram illustrating a preferred embodiment of the system in accordance with the present invention,

FIG. 3 is a flow diagram illustrating the functionality of a preferred embodiment of the present invention, and

FIG. 4 is a signal level example when a mobile terminal is in soft handover.

### DETAILED DESCRIPTION OF THE INVENTION

Reference will now be made in detail to the embodiments of the present invention, examples of which are illustrated in the accompanying drawings.

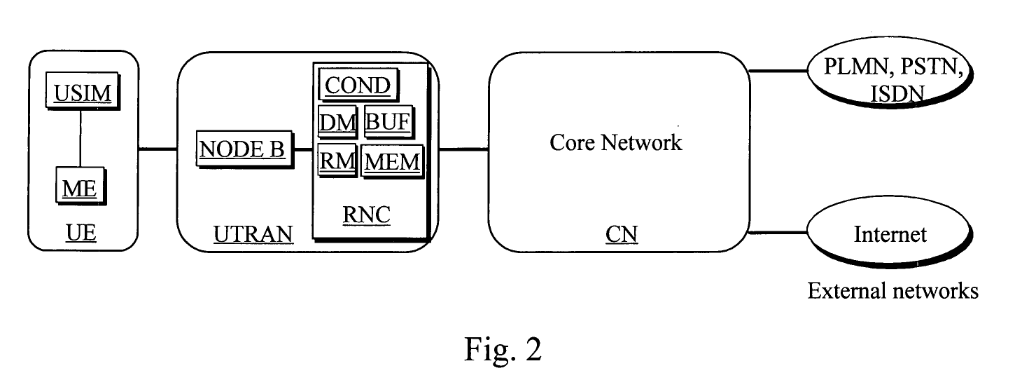

FIG. 2 represents a preferred embodiment of the system of the present invention. The system comprises user equipment UE consisting of mobile equipment ME and a UMTS Subscriber Identity Module USIM. The user equipment UE refers preferably to a mobile terminal, e.g. a mobile phone. The user equipment UE is connected to the Universal Terrestrial Radio Access Network (UTRAN). In this example, only node B and Radio Network Controller (RNC) are represented to be included in the RNC. The UTRAN is connected to the core network CN through which various services and networks, e.g. Public Switched Telephone Network (PSTN), Public Land Mobile Network (PLMN), Integrated Services Digital Network (ISDN) and the Internet can be utilised.

In FIG. 2, the RNC comprises one or more condition parameters COND. The condition parameters comprise, for example, a first timer T₁ and a second timer T₂. The RNC comprises also means DM for discarding the relocation and/or anchoring request if one or more condition parameters COND are not fulfilled. The system also comprises means RM for resetting the first T₁ and the second timer T₂ and a memory MEM for storing anchoring and/or relocation requests. In another embodiment, instead of timers, one or two adaptive thresholds, H₁ and H₂, can be used. The adaptive thresholds preferably refer to adaptive hysteresis. The RNC comprises also a data buffer BUF where the data to be sent to the mobile terminal in one or more packet calls is stored. The aforementioned means, timers and the buffer are implemented in a way known to a man skilled in the art and are therefore not described in more detail.

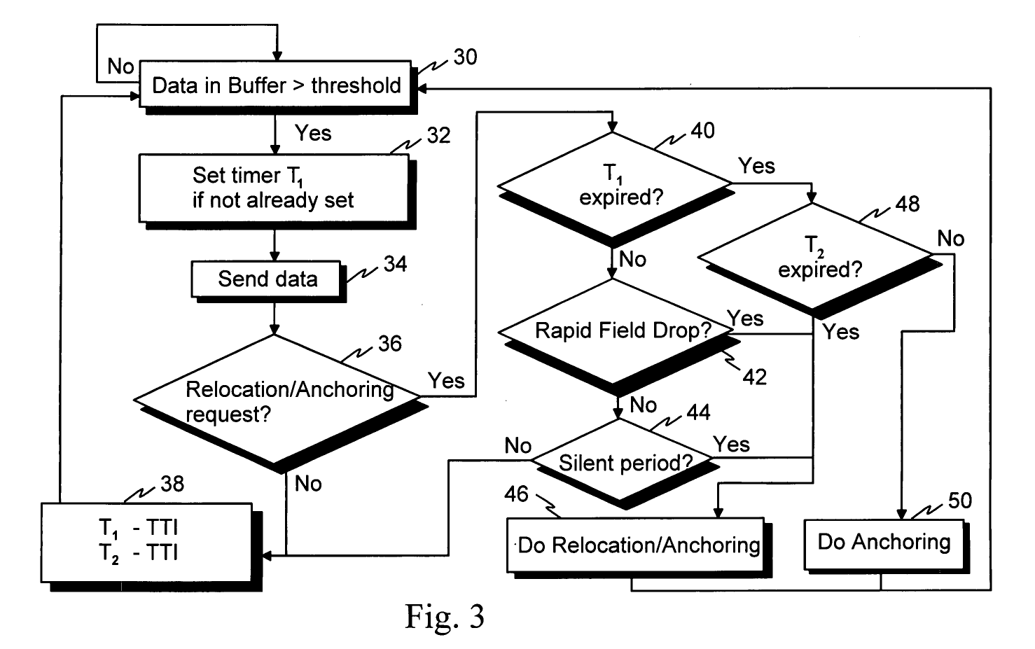

FIG. 3 represents an exemplary flow diagram of the present invention. The buffer contains data to be sent to the mobile terminal. The method presented in the present invention is used when the amount of data in the buffer exceeds a predetermined threshold value. If the data in the buffer exceeds a certain threshold value the transmission begins from the buffer, as represented in box 30. In order to avoid relocation and anchoring during the transmission of a short packet call, a first timer T₁ at the start of a packet call is started, as represented in box 32. The timer can be triggered e.g. by a certain amount of user data in the buffer. Specially, if relocation or anchoring is allowed during the starting phase, the triggering limit should be more than 100 bytes. Relocation is seen as the start of a new transmission, i.e. T₁ is started again. In another embodiment, also a second timer T₂ is started at the same time as the T₁. The second timer is typically longer than the first one.

The data is sent to the mobile terminal, as represented in box 34. If a relocation or anchoring request is not requested within e.g. Transmission Time Interval (TTI), the timer values (T₁ and T₂) are decremented by the TTI, as represented in boxes 36 and 38. The transmission time interval indicates how often data arrives from higher layers.

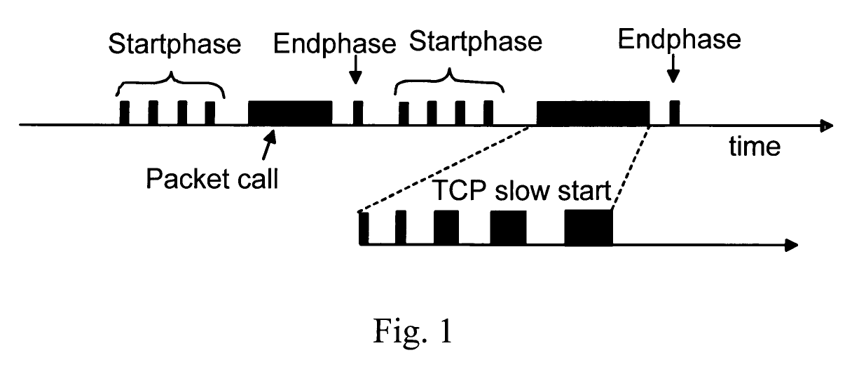

It must be noted that data can be sent to the mobile terminal even if the buffer contains less data than the threshold value. In this case, however, the method presented here should not be used. The method presented here is not triggered before the threshold value is exceeded and the timers are set. The threshold value can also be set to zero. If the threshold value is set, for example, to 100 bytes, the method presented here is not utilised during the start phase of FIG. 1 because those packets are probably 40-60 bytes of size.

If a relocation or anchoring request is received, the first timer T₁ value is checked, as represented in box 40. As long as the first timer T₁ has not expired, it is not allowed to perform relocation or anchoring. If the first timer T₁ has not expired, relocation or anchoring may be performed only for compelling reasons. One reason can be a rapid field strength drop, as represented in box 42. The signal level may drop for some reason very fast. Only a fast relocation can save the call. Only if the rapid signal level drop cannot be handled by the power control of the original cell, and this affects the frame error rate (QoS), a radio handover and possibly relocation is needed. This is appropriate especially for the cases where there is no soft handover, e.g. in the GSM, General Packet Radio Service (GPRS), EGPRS or in the Downlink Shared Channel (DSCH) or the UTRAN of the IP-RAN. In such a case, the main objective is to keep the signal in one cell if the signal level is quite reasonable even if a handover request arrives. The handover decisions are usually made by relative measures to the neighbouring cells signals. If the absolute value of the original signal is sufficient, it is probably better to hold on the original cell if, at the same time, it is predicted that the packet call will be short.

Another reason for relocation or anchoring is when a gap in the transmission appears, as represented in box 44. This gap will often be one of the silent periods in the transmission, like the reading times between packets. Then it is possible to perform relocation and anchoring, as represented in box 46.

The second timer T₂ can be used, of course, also in a non soft handover case. This, however, requires anchoring possibility for a non soft handover case which might not be supported, e.g. for some channels in the UTRAN of the IP-RAN and for none of the channels in the GERAN. Another way of avoiding unnecessary relocation and anchoring is to set two adaptive thresholds, H₁ which is used for anchoring, and H₂ which is used for relocation. H₂ should be equal or higher than H₁. H₁ and H₂ preferably refer to hysteresis levels.

After the first timer T₁ has expired anchoring is allowed as described above, as represented in boxes 48 and 50. However, after the second timer T₂ has expired it is also allowed to perform relocations, as represented in boxes 48 and 46. This way unnecessary relocations are avoided. For example, when a mobile terminal is using multiple radio connections (soft handover), the set of active radio connections may be updated frequently. If the radio connection to the master cell is lost, in a traditional system the relocation is performed. On the other hand it is very probable that the radio connection is lost for some temporary cause and it will recover in few seconds. Therefore, the relocation should not be performed right away but a timer should be used. It is also probable that the active packet call will end in a few seconds, and therefore, relocation is not necessary. It may take more time to relocate and send the data using a good radio connection than send the data with the old connection or, if anchoring is possible, by an anchored leg. In case the connection to which the anchoring or relocation is requested is not in soft handover, the rejection of the anchoring or relocation may also be a rejection of a hard handover. However, if soft handover is possible, soft handover legs can be limited by high hysteresis limits.

In one embodiment of FIG. 3, the values of the parameters (T₁ and T₂; H₁ and H₂) can be modified so that packet calls may not be wanted to anchor, whereas handovers should be prevented. This can be achieved by setting T₁=T₂ or H₁=H₂.

In one embodiment of FIG. 3, a request (relocation or anchoring) that is not performed is stored in memory. When the first and/or second timer have expired, the request is re-evaluated, and relocation or anchoring is performed, if necessary.

In one embodiment of FIG. 3, a hard radio handover may be denied with the method of the present invention in some cases. That is, if the radio hard handover requires relocation (the RNC changes, or the IP BTS changes) relocation/anchoring may be denied by the timer T₁. If the signal is not bad, or it is not a silent time, the handover is also denied. After T₁ has expired, radio handover is not affected anymore, but only the choosing between anchoring and relocation. For soft handover connections it is naturally possible to use high hysteresis values to get about the same effect.

In FIG. 3, the following two methods are described to minimise the number of anchoring and relocations:
Add a first timer for relocation and anchoring at the start of a transmission in order to avoid unnecessary anchoring and relocations.

Add a second timer, which is used for relocations at the start of the transmission in order to avoid ping-pong relocations.

The transmission of a packet call takes typically less than a few seconds. Within this period it is very likely that the signal level will stay quite constant, i.e. during the packet call transmission no relocation or anchoring should be done. During the silent periods relocation can be made, since no delay will be noticed (no data is transmitted). When the quality decreases very fast, the timer may prevent a relocation and anchoring case. This may cause very bad quality or even call drops. This can be prevented by only allowing certain kinds of handovers even if the timer has not expired.

When handover is done, it triggers either anchoring or relocation. Therefore, the present invention lowers the number of handovers needed, and thus the number of anchoring and relocation cases.

The timer values may be determined using the idea of the patent application PCT/FI01/01055 of the applicant. The statistical models based on the TCP/UDP (User Datagram Protocol) port numbers may provide useful information. For example, if some services are known to be lasting less than three seconds with a 64 Kbps bearer with 80% probability, the timer values can be set for it very accurately, and the timer values are different than for a service that has 80% limit at 20 seconds. The shorter the expected packet call, the more strict limits for the relocation should be set.

In one embodiment of FIG. 3, both timers and adaptive thresholds, e.g. adaptive hysteresis, are used at the same time.

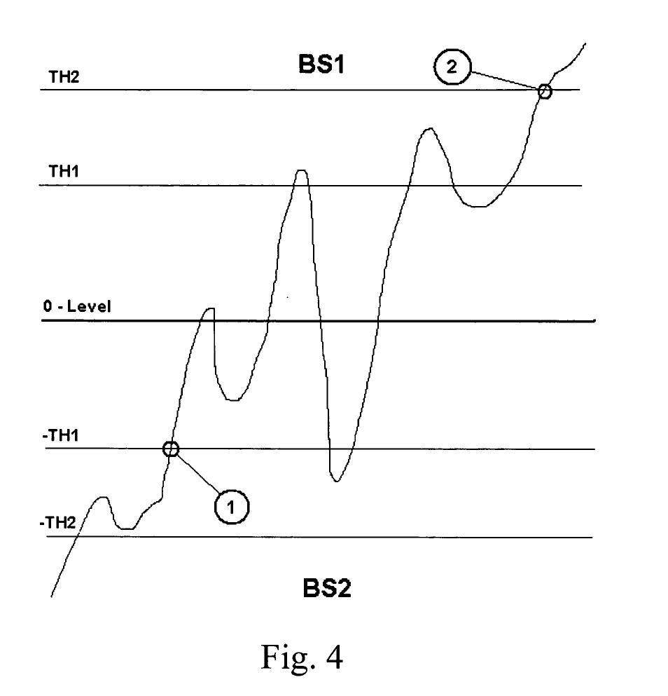

FIG. 4 represents an embodiment of the present invention using hysteresis. The curve in the FIG. 4 is the difference between signal levels BS1 and BS2, and the active set consists of only BS2 at the beginning. When the difference between the signal levels increases, the −Th1 level is reached at point 1. The base station BS1 is added to the active set and both base stations send/receive the data and the mobile is in soft handover. The BS2 is removed from the active set when point 2 (TH2) is reached, as illustrated at point 2. After this the mobile terminal is not anymore in soft handover.

Traditionally, at point 2 either relocation or anchoring would be performed. In one embodiment of the present invention at point 2, if the first timer T₁ has not expired, relocation and anchoring are both rejected. Also the leg deletion must be prevented and the mobile terminal kept in soft handover by increasing level TH2. In another embodiment at point 2, if the first timer T₁ has not expired, depending on the second timer T₂, either relocation or anchoring is performed. Anchoring is chosen, if the second timer T₂ has not expired. If the T₂ has expired, relocation is performed. The request, however, can be stored for later use. When the timer or timers have expired, it can be re-evaluated whether to perform relocation or anchoring or neither.

In case of a hard handover, there would be only two limits, L1 and L2 (instead of four (−TH1, −TH2, TH1 TH2) as in a soft handover case). Limit L1 for going from the base station BS1 to the base station BS2, and limit L2 for going back to the base station BS1.

It is obvious to a person skilled in the art that with the advancement of technology, the basic idea of the invention may be implemented in various ways. The invention and its embodiments are thus not limited to the examples described above, instead they may vary within the scope of the claims.

1. A method for avoiding unnecessary handovers, relocations and/or anchoring during packet calls in a wireless telecommunication system,
storing data to be sent to a mobile terminal in a data buffer;
characterised in that the method further comprises the steps of:
sending the data from the buffer to the mobile terminal when the amount of data in the buffer exceeds a predetermined threshold value;
receiving a relocation or anchoring request; and
performing relocation or anchoring only if one or more conditions are fulfilled.

2. The method according to claim 1, characterised in that when the predetermined threshold value is exceeded, and the data is sent to the mobile terminal, the method comprises the steps of:
starting a first timer for carrying out a relocation or an anchoring procedure; and when relocation or anchoring is requested; and
performing relocation or anchoring only if the first timer has expired.

3. The method according to claim 1, characterised in that when the predetermined threshold value is exceeded, and the data is sent to the mobile terminal, the method comprises the steps of:
starting a first timer and a second timer for carrying out a relocation or an anchoring procedure; and when relocation or anchoring is requested;
performing anchoring only if the first timer has expired; or
performing relocation only if the first and the second timers have expired.

4. The method according to claim 2, characterised in that the method further comprises the step of:
if the first timer has not expired, denying a hard handover if the signal level is adequate, or if it is not a silent period.

5. The method according to claim 2, characterised in that the method further comprises the steps of:
storing the relocation or anchoring request on a memory; and
re-evaluating the request when the first and/or second timers have expired.

6. The method according to claim 2, characterised in that the method comprises the step of:
starting the first and/or the second timer again when relocation or anchoring is performed.

7. The method according to claim 1, characterised in that the method comprises the steps of:
setting a first adaptive threshold for carrying out a relocation or an anchoring procedure; and when relocation or anchoring is requested; and
performing relocation or anchoring only if the first adaptive threshold is triggered.

8. The method according to claim 1, characterised in that the method comprises the steps of:
setting a first and a second adaptive threshold values for carrying out a relocation or an anchoring procedure; and when relocation or anchoring is requested;
performing anchoring only if the first adaptive threshold is triggered; or
performing relocation only if the first and the second adaptive thresholds are triggered.

9. The method according to claim 1, characterised in that allowing relocation or anchoring even if one or more conditions are not fulfilled if:
experiencing a rapid signal field strength drop; or
a gap in the transmission occurs.

10. A system for avoiding unnecessary handovers, relocations and/or anchoring during packet calls in a wireless telecommunication system, the wireless telecommunication system comprising:
a mobile terminal (UE) to which packet calls are established;
a network node (RNC) containing a data buffer (BUF), the data buffer (BUF) comprising the data to be sent to the mobile terminal (UE) in one or more packet calls;
characterised in that the system further comprises:
one or more condition parameters (COND) for carrying out a relocation or an anchoring procedure; and
means (DM) for discarding the relocation or anchoring request if one or more conditions (COND) are not fulfilled.

11. The system according to claim 10, characterised in that the condition parameters comprise the first (T₁) and the second (T₂) timer.

12. The system according to claim 10, characterised in that the system comprises means (RM) for resetting the first (T₁) and the second timer (T₂).

13. The system according to claim 10, characterised in that the condition parameters comprise the first (H₁) and the second (H₂) adaptive threshold.

14. The system according to claim 13, characterised in that the first (H₁) and the second (H₂) adaptive thresholds refer to adaptive hysteresis.

15. The system according to claim 10, characterised in that the system further comprises a memory (MEM) for storing anchoring and/or relocation requests.
